(19) United States
(12) Patent Application Publication
(10) Pub. No.: US 2026/0371449 A1
(43) Pub. Date: Nov. 19, 2026

(54) CONDUCTIVE HEATING SYSTEM UTILIZING PTC ELEMENT WITH FLEXIBLE HEAT SPREADER

(71) Applicant: Promethient, Inc., Traverse City, MI (US)

(72) Inventors: Chad Pacilli, Windsor (CA); Zachary Cauchy, Kingsley, MI (US); Dan Pomeroy, Traverse City, MI (US)

(21) Appl. No.: 19/682,314

(22) Filed: May 19, 2026

Related U.S. Application Data
(60) Provisional application No. 63/808,261, filed on May 19, 2025.

(51) Int. Cl. H05B 3/34; A47C 7/74; B60H 1/22; F28F 21/02; H05B 1/02

(52) U.S. Cl. CPC H05B 3/342; A47C 7/748; B60H 1/2227; F28F 21/02; H05B 1/0238; H05B 1/0272; H05B 2203/02; H05B 2203/029

(57) ABSTRACT

A thermal module for heating an occupant support surface is provided. The module includes a positive temperature coefficient (PTC) heating element that converts electrical energy into thermal energy and self-regulates to limit a maximum temperature. A flexible heat spreader, incorporating a graphene-based material with high thermal conductivity, is thermally coupled with the PTC heating element to distribute heat across the support surface. The flexible heat spreader includes at least one flexible sheet and may be configured in various arrangements to conform to non-planar seating surfaces. A cover may be partially disposed over the occupant support surface such that the heat spreader conductively transfers thermal energy between the PTC heating element and the cover. The module may further include a thermal feedback device, such as a thermostat, thermistor, or electronic control unit, configured for temperature monitoring and control.

### CROSS-REFERENCE TO RELATED APPLICATION

This application claims the benefit and priority under 35 U.S.C. §119(e) of U.S. provisional application Ser. No. 63/808,261, filed on May 19, 2025, the content of which is incorporated herein by reference in its entirety.

### TECHNICAL FIELD

The present disclosure relates to heating systems and devices and more specifically to thermally conductive heating systems that incorporate flexible heat spreaders and positive thermal coefficient (PTC) heating elements.

### BACKGROUND

Heating systems designed for occupant environments are well known, including those adapted for vehicle seating as well as recreational and indoor furnishings. It is common for such heating systems to convert electrical energy into thermal energy and conductively transfer the resulting heat to the occupant and surrounding environment. In recent advancements, engineering efforts have focused on the integration of advanced materials and design strategies to enhance thermal distribution, packaging efficiency, and overall reliability. Moreover, many conventional heating solutions continue to face obstacles, such as the safe routing of electrical components away from direct user contact, the increased desirability to provide low power consumption heating, and the structural complications associated with embedding heating elements within the seating or cushioning assemblies. These challenges underscore the need for improved approaches that can reliably and efficiently deliver heat across a target surface.

### SUMMARY

The present disclosure provides a conductive heating system and corresponding thermal module for heating an occupant support surface, such as for various implementations in furniture and seats of all types, including various types of vehicles, child seats, aviation, marine, motorcycles, powersports, and the like. The thermal module has a positive temperature coefficient (PTC) heating element configured to convert electrical energy from a power supply into thermal energy and a flexible heat spreader that is thermally coupled to, but electrically isolated from, the PTC heating element. The PTC heating element can be used instead of other electro-thermal devices such as thermoelectric devices (TEDs), which can require heat sinks and other components as well as more robust control circuitry.

In one aspect of the disclosure, a thermal module for heating an occupant support surface is provided that includes a positive temperature coefficient (PTC) heating element adapted to convert electrical energy into thermal energy. The PTC heating element is operably connected in thermal communication with a flexible heat spreader. The flexible heat spreader includes a flexible sheet that incorporates a graphene‐based material (e.g., graphene and graphite-based materials) that conductively distributes the generated thermal energy toward distal portions of the flexible sheet, such as to disperse the generated heat over contact areas of the seating surface. The flexible sheet is in closer communication with the occupant surface, which is exposed to flexing, compression, creasing, and is electrically isolated from the electro-thermal conversion device (PTC). This is safer and more reliable compared to traditional surface heating technology, which commonly converts electrical energy to heat energy close to the highly active occupant surface. Additional flexible sheets may be incorporated in other examples, such as an upper flexible sheet in direct thermal communication with the top surface of the heating element and a lower flexible sheet in direct thermal communication with the bottom surface of the heating element.

In some examples, the flexible sheet material provides a thermal conductivity greater than 500 W/mK or more preferably greater than 2,000 W/mK, while being designed to flexibly conform to non-planar and actively altering areas of occupant support surfaces. The flexible sheet or sheets, in some instances, are bonded to the heating element via a thermally conductive adhesive, such as a tape, film, glue, or the like. In some implementations, the PTC heating element may self‐regulate to limit the maximum temperature to a predefined threshold. In addition, the thermal module operates within a voltage range of 5 to 240 V AC/DC, and in some examples, a thermostat, in communication with the PTC or the heat spreader, is connected to control the delivery of thermal energy. Further, a foam piece may be positioned over the upper flexible sheet, with distal portions extending therefrom. And in some implementations, an additional heating element is incorporated in a switching circuit with the other heating element to provide selectable high or low heat outputs.

In another aspect of the disclosure, a thermal module for heating an occupant support surface provides a self‐regulating positive temperature coefficient (PTC) heating element that both converts electrical energy into thermal energy and limits the generated thermal energy at the occupant surface to below approximately 50° C. A flexible heat spreader is thermally coupled to the heating element and includes a flexible sheet material that is adapted to distribute the thermal energy over an extended portion of the support surface. Also, a thermostat is operatively connected to the heating element to monitor and adjust the energy delivery, thereby ensuring that the occupant support surface is maintained within a temperature range of approximately 34° C to 43° C. In some examples, the flexible sheet material exhibits a thermal conductivity in a range of approximately 350 to 4000 W/mK, and the flexible heat spreader is bonded to the heating element using a thermally conductive adhesive. Moreover, the heat spreader is flexibly adapted to conform to non-planar surfaces, and optionally, a second heating element may be electrically connected in a switching circuit in order to provide selectable heat outputs.

In yet another aspect of the disclosure, a heating system for a seat is provided. The system includes an electrical power supply configured to deliver electrical energy to a positive temperature coefficient (PTC) heating element that transforms the electrical energy into thermal energy. A flexible heat spreader is provided with at least one flexible sheet that incorporates a thermally conductive material and is arranged to conductively distribute the generated thermal energy over an extended portion of the seat surface. The system may include, in some examples, a cushion positioned below the heating element and the heat spreader, where the cushion does not include, and the heating element is not connected to, a heat sink. The heating element is configured to be self‐regulating to limit the maximum temperature for occupant safety. In some implementations, additional features include a thermostat for controlling thermal energy delivery, such that the system is configured so that the seat surface temperature is maintained within a range of approximately 34° C to 43° C. In additional implementations, a foam piece is disposed over the flexible sheet with distal portions extending therefrom. Moreover, a protective outer layer on the heat spreader may be provided to shield the graphene‐based material from environmental damage. In some examples, the system further includes a seat frame and a seat cover arranged so that the flexible heat spreader moves conformably with the seat cover during use.

The flexible heat spreader may take various shapes and configurations in different implementations, including, but not limited to, X-shaped, V-shaped, strip, or laminated configurations. In some examples, the heat spreader is provided as a peel-and-stick assembly attached to a foam substrate, incorporated within a foam carrier having a recess for receiving the PTC element, or as part of a laminated assembly combining trim material, heater, and backer foam.

According to another aspect of the disclosure, a method of heating an occupant support surface is provided. The method includes supplying electrical energy from a power source to a self‐regulating positive temperature coefficient (PTC) heating element that converts electrical energy into thermal energy, and transferring the thermal energy conductively from the heating element to a flexible heat spreader that includes at least one flexible sheet incorporating a graphene‐based material. In some examples, the flexible heat spreader is thermally coupled to the heating element to distribute the thermal energy over an extended portion of the occupant support surface, with the self‐regulating heating element functioning to limit the maximum temperature, such as to limit the temperature to below approximately 50° C. Further, the method may include incorporating a thermostat or temperature sensing device or circuit to monitor and adjust the delivery of electrical energy to maintain the support surface temperature within a range of approximately 34° C to 43° C. In some examples, the heat spreader includes an upper sheet in direct thermal communication with a top surface of the heating element and a lower sheet in direct thermal communication with a bottom surface of the heating element. The graphene‐based material typically exhibits a thermal conductivity greater than 500 W/mK, and in certain examples, the thermal conductivity may exceed 2000 W/mK. And, optionally, a second heating element may be integrated in a switching circuit to provide selectable high or low heat outputs.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a schematic side view of a seat structure with an occupant support surface integrated with a thermal module having a PTC heating element and a flexible heat spreader.

FIG. 2 is a schematic cross-sectional view of the thermal module shown in FIG. 1 with the PTC heating element and the layered configuration of the flexible heat spreader.

FIG. 3 is an upper perspective view of a thermal module on a seat cushion.

FIG. 4 is a side perspective view of the thermal module shown in FIG. 3 revealing the PTC heating element positioned between two sheets of the flexible heat spreader.

FIG. 5 is an upper perspective view of a thermal module having a flexible heat spreader thermally coupled to a PTC heating element.

FIG. 6 is an upper perspective view of the thermal module shown in FIG. 5 having a foam piece for thermal isolation and comfort disposed on the flexible heat spreader over the PTC heating element.

FIG. 7 is a lower perspective view of the thermal module shown in FIG. 6 with two heating elements and a thermostat disposed between sheets of the flexible heat spreader.

FIG. 8 is a side perspective view of the thermal module shown in FIG. 6 with the two heating elements and the thermostat disposed between the sheets of the flexible heat spreader.

FIG. 9 is an upper view of the thermal module shown in FIG. 5 having one of the flexible sheets removed to expose the heating elements and the thermostat.

FIG. 10 is a perspective view of the partial thermal module shown in FIG. 9.

FIG. 11 is a schematic diagram of an electrical circuit configuration for operating a single PTC heating element integrated with a flexible heat spreader.

FIG. 12 is a schematic diagram of a dual-setting electrical circuit configuration for controlling heat output of two PTC heating elements.

FIG. 13 is a schematic diagram of an electrical circuit configuration for a dual-area heating system for a back surface and a seat surface.

FIGS. 14 and 15 are graphs illustrating the thermal performance of a PTC heating element over time.

Like reference numerals indicate like parts throughout the drawings.

### DETAILED DESCRIPTION

The following detailed description provides illustrative examples of the described technology and associated embodiments. These examples are intended to facilitate understanding of the described technology but are not meant to limit the scope of the subject matter. The described technology pertains broadly to heating modules, systems, and devices, particularly those incorporating positive temperature coefficient (PTC) heating elements and flexible heat spreaders, such as flexible composite sheet materials, for efficient and uniform thermal energy distribution. Applications may include, but are not limited to, occupant support surfaces in vehicles, outdoor seating, battery thermal management, food and beverage, radiant floor heating, and other environments requiring safe and effective heating solutions.

As described herein, a positive temperature coefficient (PTC) heating element is a type of resistive heating component whose electrical resistance increases as its temperature rises. This behavior is attributed to the material properties of the PTC element, which are typically comprised of ceramic or polymer-based materials doped with conductive particles. The increase in resistance reduces the flow of electrical current through the heating element, thereby naturally limiting the amount of heat generated. This self-regulating behavior allows the heating element to limit its maximum temperature without requiring external control mechanisms, making it generally more cost-effective and energy-efficient.

The PTC heating element may take various geometric forms depending on the application, including but not limited to a flat or planar rectangular element, a cylindrical element, a disc-shaped element, or other three-dimensional forms. As used herein, references to a "first surface" and a "second surface" of the PTC heating element are intended to describe any two surfaces of the heating element, regardless of its shape or orientation, that are available for thermal coupling with the flexible heat spreader. For example, in a planar rectangular PTC element, the first and second surfaces may correspond to the opposing broad faces of the element. In a cylindrical PTC element, the first and second surfaces may correspond to opposing curved surfaces or flat end surfaces, or to a primary outer surface and a secondary surface. This terminology is not intended to limit the heating element to any particular geometry.

As used herein, a "thermal feedback device" refers broadly to any device, component, or circuit configured to monitor temperature and adjust or interrupt the delivery of electrical energy to the PTC heating element in response to detected temperature conditions. The thermal feedback device may include, without limitation, a line-voltage thermostat, a bimetallic thermostat, a thermistor, a temperature sensor, an electronic control unit (ECU), or any combination thereof. Where a thermistor is employed, it may be operatively coupled to an ECU or control circuit that processes the temperature signal and modulates energy delivery accordingly. In some implementations, a timer may also be incorporated into the control circuit to limit the duration of heating operation, such as to automatically shut off the system after a predefined period of time. The use of the term "thermostat" in the context of the figures and circuit diagrams herein is intended as one example of a thermal feedback device and is not intended to limit the scope of the thermal feedback device to a mechanical thermostat.

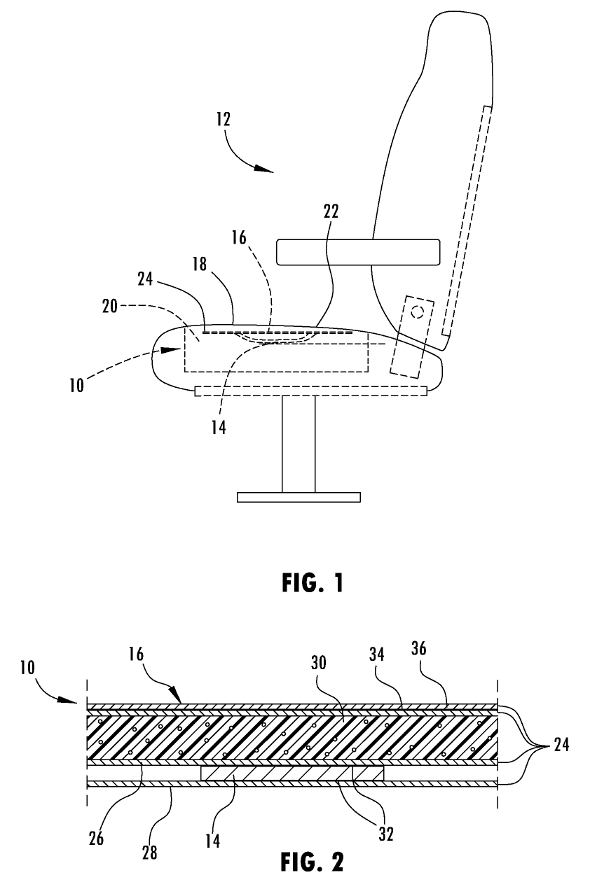

Referring to FIG. 1, a thermal module 10 may be incorporated into a seat 12 to use a heating device 14 and a flexible heat spreader 16 to provide or otherwise transfer thermal energy in the system to conductively heat an occupant of the seat when the occupant is in contact with the seat surface 18. In additional examples, the heating device may be incorporated in other conductive heating applications, such as garments, furniture, and seats of all types, including seats for various types of vehicles, child seats, industrial equipment, aviation, marine, railcars, powersports, motorcycles, and the like. The heating device 14 of the thermal module and system disclosed herein is a solid-state electro-thermal conversion device that converts electrical energy to thermal energy, and specifically, the heating device is embodied as one or more PTC heating elements 14.

As shown in FIG. 1, the thermal module 10 is provided on or in a foam cushion 20 of the seat 12. The foam cushion 20 is provided under the occupant support surface 18, and in additional examples may also or alternatively be provided at a seat back or bench. A recess is provided in a central region of the seat cushion 20 to provide an area for locating the heating element 14 of the thermal module 10 at a lowered location from the upper surface 18. The foam cushion 20 may also provide a soft and deformable surface for the occupant to comfortably and ergonomically sit. An outer cover 22 or seat cover, such as a fabric or non-fabric seat upholstery material or cover stock, is supported by the foam cushion 20. The seat cover 22 provides a thermal resistance that must be overcome by a temperature differential between the occupant and the composite structure extending from the electro-thermal conversion device. In addition, other components of the seat system can indirectly add some heat into the system where the electro-thermal conversion device can also remove at least some of the heat in these additional components.

As also shown in FIG. 1, the flexible heat spreader 16 of the thermal module 10 is thermally coupled to and electrically isolated from the PTC heating element 14, so as to be configured to distribute the generated thermal energy uniformly across the occupant support surface 18. The flexible heat spreader 16 includes flexible sheets 24 that are generally disposed between the foam cushion 20 and the seat cover 22. As depicted, the flexible sheets 24 of the heat spreader 16 are composite structures that incorporate a thermally conductive material, such as a graphene or graphite-based material. Specifically, the composite structure of the flexible sheets 24 may comprise a graphene sheet material, which may include graphene, pyrolytic graphite, highly oriented dense graphite, and combinations thereof. In some examples, the flexible sheets 24 may include a protective outer layer, such as a laminate, to shield the thermally conductive material from environmental damage. These thermally conductive materials of the flexible sheets can provide thermal conductivity of the sheet material that is greater than 500 W/mK, and in some instances greater than 2,000 W/mK, such as in the range of 500 to 2,000 W/mK or the range of 1,000 to 4,000 W/mK. This high thermal conductivity facilitates efficient heat transfer from the PTC heating element 14 to distal portions of the seat surface 18, thereby minimizing localized hot spots and enhancing overall occupant comfort.

The flexible sheets 24 may take various shapes and configurations, including but not limited to X-shaped, V-shaped, single strip, folded strip, or laminated configurations, so as to cover and thermally communicate with the desired areas of the occupant support surface. For example, a single strip of flexible sheet material may be folded over the PTC heating element to provide thermal communication with both a first surface and a second surface of the heating element with a single piece of material. The flexible heat spreader may also be provided as a peel-and-stick assembly bonded to a foam substrate, incorporated within a foam carrier having a recess for receiving the PTC element, or provided as part of a laminated assembly combining trim material, heater, and backer foam.

In one implementation, a single flexible sheet strip may be employed as the heat spreader in lieu of two separate sheets. In this configuration, the single strip is folded over the PTC heating element such that a first portion of the strip is in thermal communication with the first surface of the heating element and a second portion of the strip, formed by the fold, is in thermal communication with the second surface of the heating element. The fold may be located at one end of the heating element, with the distal portions of each folded section extending outwardly in opposing or diverging directions from the heating element to distribute thermal energy across the occupant support surface. This folded single-strip configuration reduces the number of components, simplifies assembly, and maintains the requisite thermal coupling with both surfaces of the PTC heating element. The thermally conductive adhesive described herein may be used to bond both portions of the folded strip to their respective surfaces of the heating element.

In additional implementations, the thermal module may be assembled using a peel-and-stick configuration in which the flexible heat spreader, with the PTC heating element thermally coupled thereto, is bonded to a foam substrate or other carrier material via a pressure-sensitive adhesive backing. In such a configuration, the heat spreader assembly may be applied directly to the surface of a foam cushion or seat substrate during manufacturing by removing a release liner and pressing the assembly onto the target surface, eliminating the need for a pre-formed recess in the cushion. This configuration may simplify installation and reduce manufacturing complexity while maintaining the thermal performance described herein.

In another implementation, the thermal module may be provided as a laminated assembly in which the flexible heat spreader and PTC heating element are integrated between layers of a multi-layer laminate. For example, the laminated assembly may include a trim or cover material layer, the flexible heat spreader with the PTC heating element, and a backer foam layer, all bonded together into a unitary assembly. This laminated configuration may be particularly suited for applications where the thermal module is incorporated directly into the seat cover or trim panel during manufacture. The flexible nature of the graphene-based heat spreader material allows it to conform to the contours of the laminated assembly without compromising thermal performance.

The flexible sheets 24 of the heat spreader 16, such as shown in FIGS. 1 and 2, are thermally coupled to the PTC heating element 14, which is positioned at a central region of the seat cushion 20. The flexible sheets 24 generally extend outward horizontally from the PTC heating element 14. In addition, the flexible nature of the heat spreader 16 allows the thermal module 10 to conform to non-planar surfaces, such as to flex and conform under compression of the foam cushion 20. The flexibility of the heat spreader 16 also makes the heat spreader suitable for various seat designs, including those with complex geometries. Thus, this adaptability ensures consistent heat distribution regardless of the shape or contour of the seat. Moreover, the thermally conductive material provides durability and resistance to environmental damage, rendering the heat spreader well-suited for applications in outdoor seating, vehicles, and other demanding environments.

Referring to FIG. 2, a cross-sectional schematic diagram of a thermal module 10 depicts a layered configuration of the flexible sheets 24 of the heat spreader thermally coupled to the PTC heating element 14. The heat spreader 16 includes an upper flexible sheet 26 and a lower flexible sheet 28, both of which incorporate thermally conductive materials to function as the flexible heat spreader. As referred to above, the recess in the central region of the seat cushion 20 receives the thermal module and locates the heating element 14 at a select distance from the occupant support surface 18. With the electrical circuit of the heating element 14 and corresponding wiring in the recessed area, the energy conversion occurs away from the occupant support surface, so there is no chance to create resistive shorting of a wire heating element. Keeping this circuitry away from the occupant support surface of the seat nearly eliminates the risk of damage to electrical conductors caused by ingress and egress or puncture of the surface. Similarly, this arrangement can avoid costly durability testing of newly implemented seat and trim variants, as is common in the auto industry due to the sensitivity of typical heater wire routing close to the seat surface.

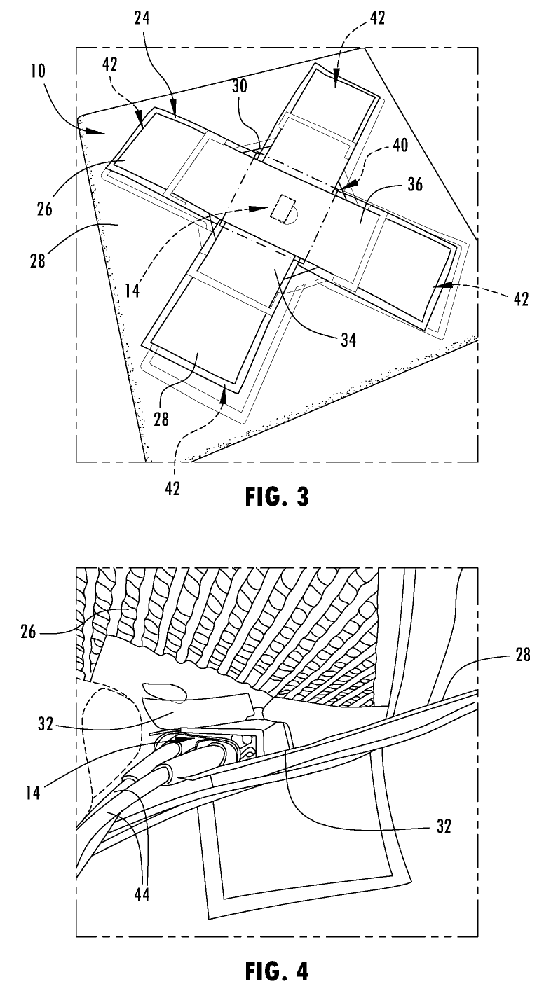

As shown in FIG. 2, to provide a cushioned layer between the heating element 14 and the occupant support surface 18, the thermal module includes a cushion or foam piece 30 that is disposed over the upper flexible sheet 26. The foam piece 30 is formed to occupy the upper remaining volume of the recess and provide a generally consistent cushioning across the seat cushion 20 (FIG. 1). In doing so, the foam piece 30 has a thickness that fills the remaining depth of the recess in the seat cushion 20. In this example, two additional flexible sheets 34, 36 are layered over the foam piece 30 opposite the upper flexible sheet 26. These two additional flexible sheets 34, 36 are thermally coupled to the extended portions of the upper and lower flexible sheets 26, 28, so as to conduct heat from the extended portions of the upper and lower flexible sheets 26, 28 centrally over the upper surface of the foam piece 30, as further shown in the example depicted in FIG. 3.

As shown in FIGS. 2 and 3, the PTC heating element 14 is centrally positioned within the thermal module 10. The heating element 14 is in direct thermal communication with both the upper flexible sheet 26 and the lower flexible sheet 28 to facilitate effective heat transfer. The upper flexible sheet 26 is thermally coupled to the top surface of the heating element 14. Similarly, the lower flexible sheet 28 is thermally coupled to the bottom surface of the heating element 14. The upper and lower flexible sheets 26, 28 each incorporate a thermally conductive material to facilitate the distribution of thermal energy from the heating element 14, primarily in the lateral or planar direction.

As further shown in FIGS. 2-4, the upper and lower flexible sheets 26, 28 and the lower flexible sheet 28 are thermally coupled to the heating element 14 using a thermally conductive adhesive 32. This adhesive provides robust thermal coupling between the components while maintaining the overall flexibility and durability of the thermal module. The adhesive may be capable of withstanding high operational temperatures, typically up to 150° C or higher, without degrading or losing its bonding strength. In the depicted example, the thermally conductive adhesive 32 is provided as a high-temperature two-sided tape; however, in additional examples, the thermally conductive adhesive may be a film, liquid adhesive, glue, or the like. For example, the thermal adhesive used in the system may be designed to facilitate efficient heat transfer from the PTC heating element to the flexible heat spreader, where the typical thermal conductivity values for such adhesives range from 1 to 10 W/mK, providing minimal thermal resistance at the interface.

Also, in further implementations, the heating element may be mechanically attached to the flexible sheets in a manner that provides consistent pressure and prevents movement of the components during operation. For example, pressure plates may be used to mechanically secure the PTC heating element to the flexible heat spreader. These plates apply uniform pressure across the contact surfaces, ensuring optimal thermal coupling and generally preventing gaps that could reduce heat transfer efficiency. The pressure plates are typically made of rigid materials that can withstand the operational temperatures of the system without deforming or losing their structural integrity, such as aluminum, stainless steel, high-performance polymers, or combinations thereof. Other examples include positional retainers, mechanical fixtures, and clamping mechanisms, such as screws, bolts, or spring-loaded clamps, which are used to secure the assembly. These mechanisms provide adjustable and controlled pressure, allowing for fine-tuning of the contact force between the PTC element and the graphene heat spreader.

Referring to FIGS. 3 and 4, a thermal module 10 is shown having a positive temperature coefficient (PTC) heating element 14 positioned centrally within the thermal module. In this example, the upper flexible sheet 26 and the lower flexible sheet 28 are each rectangularly shaped and configured in an X-shaped arrangement featuring a central overlapping region 40 with distal portions 42 extending outwardly from the overlapping region 40. The two additional flexible sheets 34, 36 that are layered over the foam piece 30 have rectangular shapes with a similar width to the upper and lower flexible sheets 26, 28. More specifically, the first additional flexible sheet 34 has ends attached to the distal portions 42 of the lower flexible sheet 28 and spans over the foam piece 30 at the overlapping region 40. Similarly, the second additional flexible sheet 36 has ends attached to the distal portions 42 of the upper flexible sheet 26 and spans over the first additional flexible sheet 34 and the foam piece 30 at the overlapping region 40. The ends of the two additional flexible sheets 34, 36 are thermally coupled to the upper and lower flexible sheets 26, 28, so as to conduct heat from the extended portions of the upper and lower flexible sheets 26, 28 centrally over the foam piece 30.

As shown in FIG. 4, the PTC heating element 14 has an aluminum shell that surrounds a ceramic element that is encased with a polyimide sleeve, where lead wires 44 extend from the ceramic element of the heating element 14. The aluminum shell defines the top and bottom surfaces of the heating element 14, which interface with the respective upper and lower flexible sheets 26, 28 via the thermally conductive adhesive 32. In this regard, the heating element 14 is in direct thermal communication with both the upper flexible sheet 26 and the lower flexible sheet 28, which facilitates efficient heat transfer. The heating element 14 is electrically connected to a power supply and may operate within a voltage range of 5-240 V AC or DC.

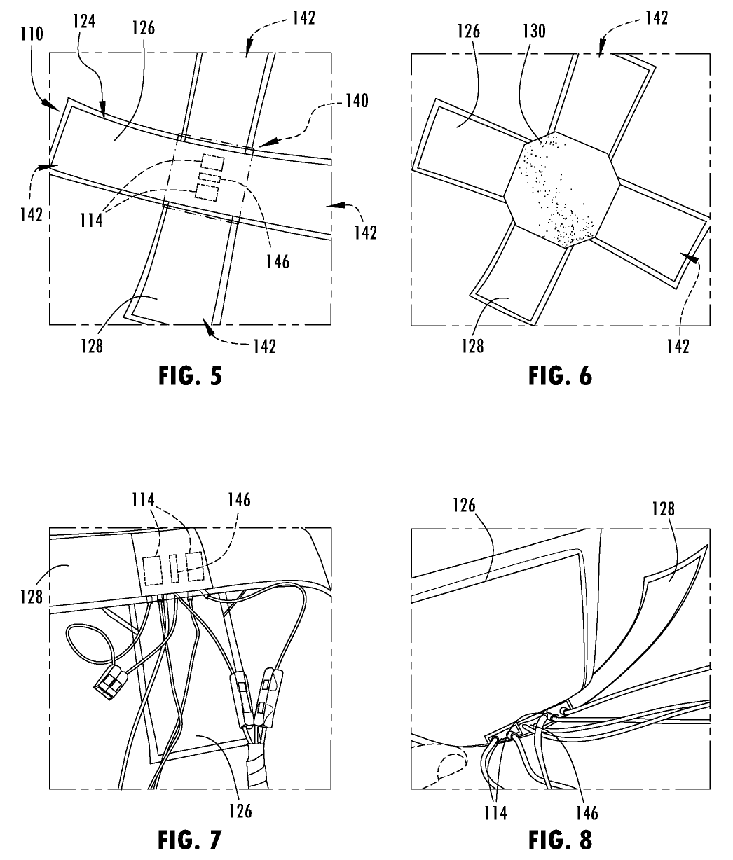

Referring to FIGS. 5-10, an additional implementation of a thermal module 110 is illustrated, incorporating two positive temperature coefficient (PTC) heating elements 114 and a flexible heat spreader 116 having upper and lower flexible sheets 126, 128. The thermal module 110 also includes a thermostat 146 that is operatively connected to the heating elements 114 to monitor and adjust the energy delivery, thereby ensuring that the occupant support surface is maintained within a temperature range of approximately 34° C to 43° C. It is contemplated that a thermostat may similarly be incorporated with the single PTC heating element arrangement shown in FIGS. 2-4. Also, the thermostat may refer to a line voltage thermostat or in additional examples may include a thermostat device or circuit, such as with a temperature sensor.

As also shown in FIGS. 5-8, the upper flexible sheet 126 and the lower flexible sheet 128 are each rectangularly shaped and configured in an X-shaped arrangement featuring a central overlapping region 140 with distal portions 142 extending outwardly from the overlapping region 140. In this example, additional flexible sheets are omitted from extending over the foam piece 130. The PTC heating elements 114 are centrally positioned in the overlapping region 140 within the thermal module 110 and are configured to convert electrical energy into thermal energy. As shown, the heating element 114 is electrically connected to a power supply and operates within a voltage range of 5-240 V AC or DC.

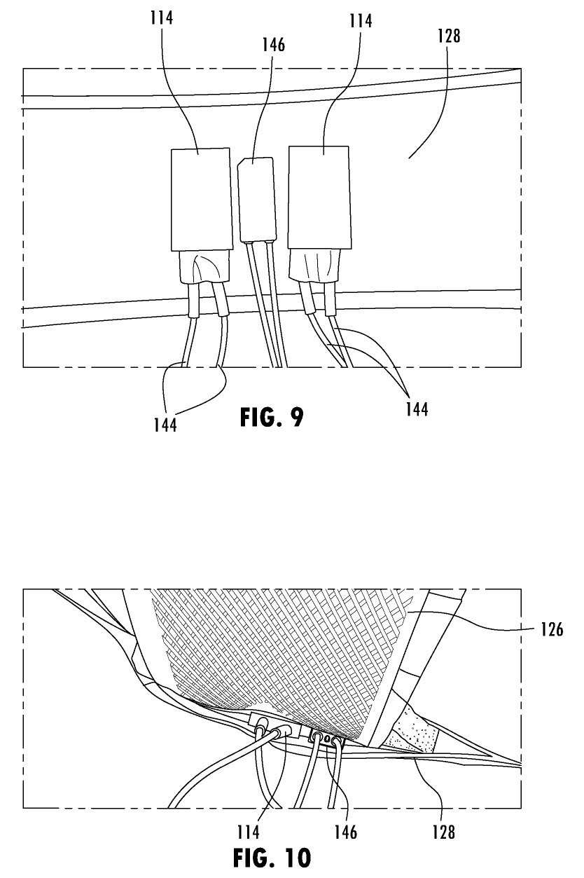

As further depicted in FIGS. 9 and 10, the graphene-based flexible sheets 126, 128 are thermally coupled to the PTC heating element 114 to facilitate efficient heat transfer. More specifically, the upper flexible sheet 126 is in direct thermal communication with the top surface of the PTC heating element 114, whereas the lower flexible sheet 128 is in direct thermal communication with the bottom surface of the heating element 114. In this configuration, both flexible sheets incorporate graphene-based materials characterized by high thermal conductivity, as described above. The PTC heating element 114 is configured to convert electrical energy into thermal energy, while the graphene-based flexible heat spreader 120 is designed to conductively distribute the generated thermal energy across an extended portion of an occupant support surface.

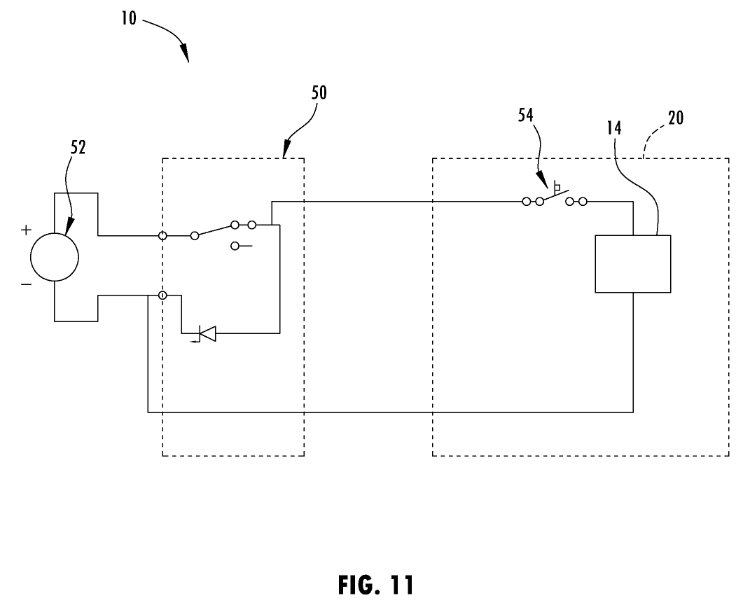

Referring to FIG. 11, a schematic diagram illustrates an electrical circuit configuration for a heating system of a thermal module 10 that operates a PTC heating element 14 integrated with a flexible heat spreader 20, such as shown in FIGS. 2-4. The configuration includes a switch assembly 50 disposed between a power source 52 and the heating element 14. The power source 52 is configured to provide a voltage range of 5 - 240 V AC or DC and is shown as a battery, but in additional examples may be a wired power source. The circuit configuration shows a thermostat illustrated as a temperature switch 54 for operating the heating element 14 between an on and off condition, redundantly managing electrical energy flow and controlling heat output. The switch 50 serves as the interface for electrical connections between the power supply and circuit components, enabling manual control of the heating system, allowing the user to select high or low heat settings, as well as an off selection.

While the circuit configuration shown in FIG. 11 depicts a thermal feedback device as a temperature switch 54, it is understood that the thermal feedback device may alternatively be embodied as a thermistor operatively coupled to an electronic control unit (ECU) or other control circuit. In such a configuration, the thermistor provides a continuous temperature signal to the ECU, which in turn modulates or interrupts the delivery of electrical energy to the PTC heating element based on the detected temperature relative to a predefined set point or range. This configuration may enable more precise temperature control compared to a simple on/off thermostat. In some implementations, both a thermostat and a thermistor may be employed in combination, with the thermostat providing a primary safety cutoff and the thermistor providing fine temperature regulation via the ECU. Additionally, a timer circuit may be integrated into the ECU or control circuit to limit the total duration of heating operation, such as automatically shutting off the heater after a predetermined period, regardless of the detected temperature.

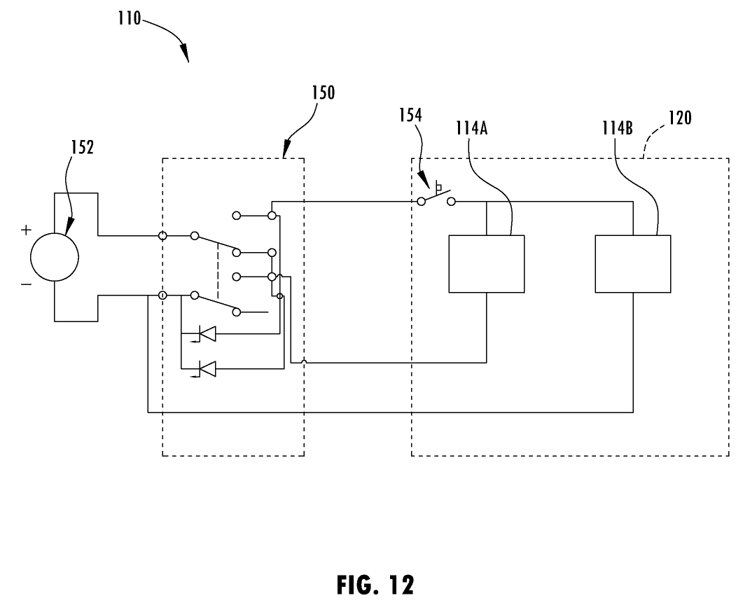

Referring to FIG. 12, a schematic block diagram illustrates a dual-setting circuit configuration for controlling heat output in the heating system of a thermal module 110. The circuit includes a switch assembly 150 disposed between a power source 152 and the heating elements 114A, 114B arranged on a heat spreader 120, such as shown in FIGS. 5-8. This configuration provides selectable high and low heat outputs using both parallel and series circuit arrangements. The illustrated boundary of the switch assembly 150 defines the operational boundary for the switching components, serving as the interface for electrical connections between the power source 152 and the switching elements. When switched to the parallel circuit, the switch 150 enables high heat output through a parallel circuit connection, allowing the heating elements 114A, 114B to operate at full capacity. In the high heat circuit, a thermostat may be provided, illustrated as a temperature switch 154, for operating the heating elements 114A, 114B between an on and off condition, redundantly managing electrical energy flow and controlling heat output. Conversely, when switched to the series circuit, the switch 150 provides reduced heat output by establishing a series circuit connection, restricting current flow and decreasing thermal energy. The switch 150 is a user-operated switch that allows manual selection between high and low heat settings, as well as an off selection.

As with the single-element circuit configuration, the thermal feedback device in the dual-setting circuit of FIG. 12, shown as temperature switch 154, may alternatively or additionally include a thermistor coupled to an ECU. Where two PTC heating elements 114A, 114B are employed, a single thermal feedback device or multiple thermal feedback devices may be used to monitor and control each element independently or dependently, as required by the application. In implementations using a single thermal feedback device for both elements, the device may be positioned at a central location between the two heating elements to provide a representative temperature reading for the overall module.

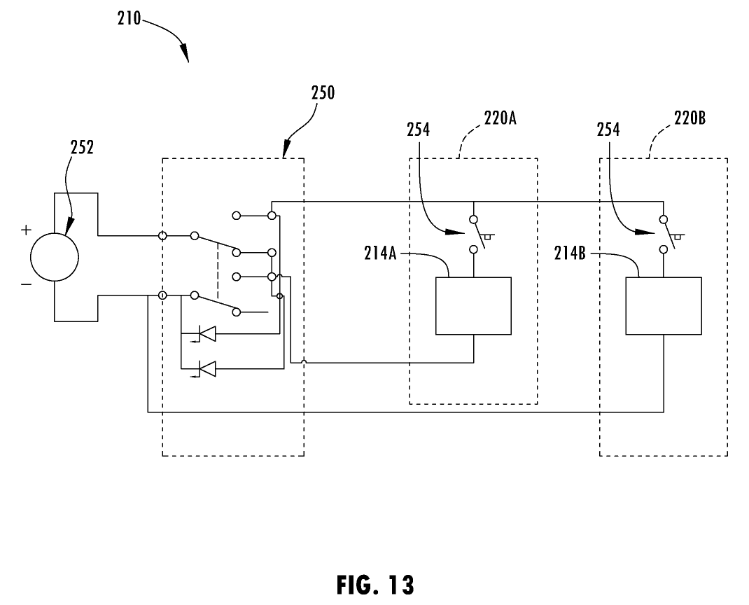

FIG. 13 is a schematic diagram of an electrical circuit configuration for a dual-area heating system of a thermal module 210, such as for integration separately in both a back surface and a seat surface of a seat. The circuit includes a switch assembly 250 disposed between a power source 252 and the heating elements 214A, 214B arranged on separate respective heat spreaders 220A, 220B. This circuit configuration, similar to the circuit shown in FIG. 12, provides selectable high and low heat outputs using both parallel and series circuit arrangements. The illustrated boundary of the switch assembly 250 defines the operational boundary for the switching components, serving as the interface for electrical connections between the power source 252 and the switching elements. When switched to the parallel circuit, the switch 250 enables high heat output through a parallel circuit connection, allowing the heating elements 214A, 214B to operate at full capacity. In the high heat circuit, two thermostats may be provided, illustrated as temperature switches 254, for operating each of the heating elements 214A, 214B between an on and off condition, redundantly managing electrical energy flow and controlling heat output. Conversely, when switched to the series circuit, the switch 250 provides reduced heat output by establishing a series circuit connection, restricting current flow and decreasing thermal energy. The switch 250 is a user-operated switch that allows manual selection between high and low heat settings, as well as an off selection. In this example, the two heating elements 214A, 214B may operate dependently such that controls are connected. However, in other examples, the two heating elements may operate and be controlled independently. In additional examples, more or fewer heating elements and heat spreaders may be located in various areas as required for the desired seat or occupant support system configuration.

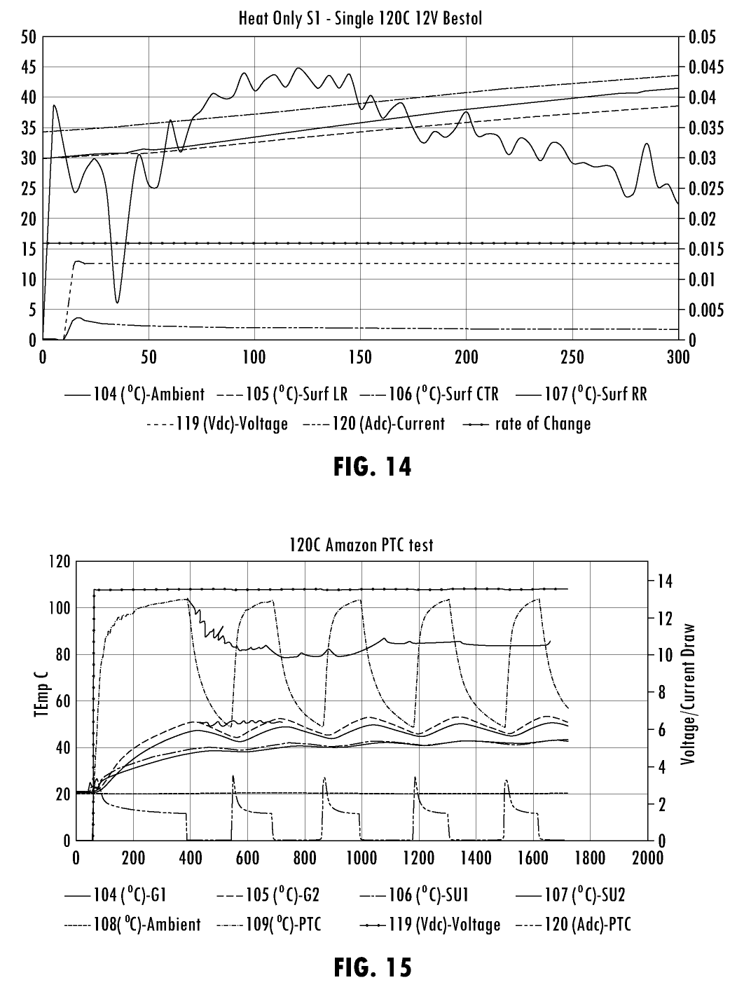

Referring to FIG. 14, the graph illustrates the thermal performance of a single 12V positive temperature coefficient (PTC) heating element 14 over time. Multiple data sets depict the relationships between temperature, electrical current, voltage, thermal output, energy consumption, and electrical resistance during operation. The temperature profile shows the heating element 14 stabilizing at a predefined threshold, highlighting its self-regulating nature for occupant safety. The electrical current initially spikes but decreases as resistance rises with temperature, aligning with the PTC property. Voltage remains stable within the operational range of the power supply to provide consistent performance. The thermal output stabilizes as the temperature reaches the threshold. Likewise, energy consumption decreases as the temperature stabilizes, demonstrating efficiency. Electrical resistance increases with temperature, further emphasizing the self-regulating behavior.

Referring to FIG. 15, the graph illustrates the thermal performance of a 12V positive temperature coefficient (PTC) heater 114 over time, showing its self-regulating behavior and efficiency. Multiple data sets depict the relationships among temperature, electrical current, voltage, thermal output, energy consumption, and electrical resistance. The temperature stabilizes at a predefined threshold, preventing overheating. Electrical current initially spikes but decreases as resistance rises with temperature, while voltage remains stable within the operational range of the power supply for consistent operation. Thermal output stabilizes, providing uniform heat distribution, and energy consumption decreases as the temperature stabilizes, demonstrating efficiency. Electrical resistance increases with temperature, further emphasizing the self-regulating nature.

For purposes of this disclosure, the term “coupled” (in all of its forms, couple, coupling, coupled, etc.) generally means the joining of two components directly or indirectly to one another. Such joining may be stationary in nature or movable in nature; may be achieved with the two components and any additional intermediate members being integrally formed as a single unitary body with one another or with the two components; and may be permanent in nature or may be removable or releasable in nature, unless otherwise stated.

Also for purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote one element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5 % of, within less than 1 % of, within less than 0.1 % of, and within less than 0.01 % of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inner,” “outer” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A thermal module for heating an occupant support surface, the thermal module comprising:
a positive temperature coefficient (PTC) heating element configured to convert electrical energy received from a power supply into thermal energy, the PTC heating element having a first surface and an opposing second surface; and
a flexible heat spreader thermally coupled to the first surface and second surface of the PTC heating element, the flexible heat spreader having at least one flexible sheet incorporating a graphene-based material, the at least one flexible sheet being electrically isolated from the PTC heating element,
wherein the flexible heat spreader is configured to conductively distribute the thermal energy generated by the PTC heating element via the graphene-based material to distal portions of the at least one flexible sheet over an extended portion of the occupant support surface.

2. The thermal module of claim 1, wherein the at least one flexible sheet comprises a first flexible sheet in thermal communication with the first surface of the PTC heating element and a second flexible sheet in thermal communication with the second surface of the PTC heating element.

3. The thermal module of claim 2, wherein the first flexible sheet and the second flexible sheet are configured in an X-shaped arrangement having a central overlapping region and distal portions extending from the central overlapping region.

4. The thermal module of claim 1, wherein the at least one flexible sheet is a single strip of flexible sheet material folded over the PTC heating element so as to be in thermal communication with both the first surface and the second surface of the PTC heating element.

5. The thermal module of claim 1, wherein the graphene-based material has a thermal conductivity greater than 500 W/mK.

6. The thermal module of claim 1, wherein the PTC heating element is self-regulating to limit a maximum temperature of the PTC heating element to a predefined threshold.

7. The thermal module of claim 1, wherein the at least one flexible sheet is coupled to the PTC heating element via a thermally conductive adhesive.

8. The thermal module of claim 1, further comprising a thermal feedback device operatively coupled to the PTC heating element or the flexible heat spreader and configured to monitor and control delivery of thermal energy, wherein the thermal feedback device comprises at least one of a thermostat, a thermistor, or an electronic control unit (ECU).

9. The thermal module of claim 1, further comprising a second PTC heating element electrically connected to the PTC heating element in a switching circuit configured to provide a selectable high heat output and a selectable low heat output.

10. The thermal module of claim 9, wherein the high heat output is provided by connecting both PTC heating elements in parallel and the low heat output is provided by connecting both PTC heating elements in series.

11. A heating system for a seat, the heating system comprising:
an electrical power supply configured to provide electrical energy;
a positive temperature coefficient (PTC) heating element electrically connected to the electrical power supply and configured to transform the electrical energy into thermal energy, the PTC heating element being self-regulating to limit a maximum temperature generated by the thermal energy to a predefined threshold; and
a flexible heat spreader in direct thermal communication with the PTC heating element and electrically isolated therefrom, the flexible heat spreader having at least one flexible sheet incorporating a graphene-based material, the flexible heat spreader configured to conductively distribute the thermal energy over an extended portion of a seat surface.

12. The heating system of claim 11, wherein the graphene-based material has a thermal conductivity in a range of approximately 350 to 4000 W/mK.

13. The heating system of claim 11, further comprising a thermal feedback device operatively coupled to the PTC heating element or the flexible heat spreader and configured to monitor and control delivery of the thermal energy to maintain the seat surface temperature within a range of approximately 34°C to 43°C, wherein the thermal feedback device comprises at least one of a thermostat, a thermistor, or an electronic control unit (ECU).

14. The heating system of claim 11, wherein the flexible heat spreader is configured to conform to non-planar configurations of the seat surface.

15. The heating system of claim 11, further comprising a cushion disposed below the PTC heating element and the flexible heat spreader, wherein the cushion does not include a heat sink.

16. The heating system of claim 11, wherein the at least one flexible sheet includes a protective outer layer configured to shield the graphene-based material from environmental damage.

17. The heating system of claim 11, further comprising:
a seat frame supporting the PTC heating element and the flexible heat spreader; and
a seat cover disposed over the flexible heat spreader to define the seat surface, wherein the flexible heat spreader is configured to flexibly conform to movement of the seat cover during use.

18. A method of heating an occupant support surface, the method comprising:
providing electrical energy from a power supply to a self-regulating positive temperature coefficient (PTC) heating element;
converting the electrical energy into thermal energy with the self-regulating PTC heating element;
conductively transferring the generated thermal energy from the PTC heating element to a flexible heat spreader having at least one flexible sheet incorporating a graphene-based material, the flexible heat spreader being thermally coupled to the PTC heating element and electrically isolated therefrom; and
distributing the generated thermal energy via the flexible heat spreader over an extended portion of the occupant support surface,
wherein the self-regulating PTC heating element limits a maximum temperature to a predefined threshold.

19. The method of claim 18, further comprising:
operatively coupling a thermal feedback device to the self-regulating PTC heating element or the flexible heat spreader,
wherein the thermal feedback device comprises at least one of a thermostat, a thermistor, or an electronic control unit (ECU), and
wherein the thermal feedback device is configured to monitor and control delivery of thermal energy to maintain the occupant support surface temperature within a range of approximately 34°C to 43°C.

20. The method of claim 18, wherein the flexible heat spreader comprises a first flexible sheet in thermal communication with a first surface of the PTC heating element and a second flexible sheet in thermal communication with a second surface of the PTC heating element, and wherein the graphene-based material exhibits a thermal conductivity greater than 500 W/mK.
